(19) United States
(12) Patent Application Publication
(10) Pub. No.: US 2021/0397231 A1
(43) Pub. Date: Dec. 23, 2021

(54) TEMPERATURE CONTROL DEVICE, INFORMATION PROCESSING APPARATUS, AND TEMPERATURE CONTROL METHOD

(71) Applicant: FUJITSU LIMITED, Kawasaki-shi (JP)

(72) Inventors: Manabu Toyoda, Yokohama (JP); Masanori Takaoka, Kawasaki (JP); Atsushi Sometani, Kawasaki (JP)

(73) Assignee: FUJITSU LIMITED, Kawasaki-shi (JP)

(21) Appl. No.: 17/235,975

(22) Filed: Apr. 21, 2021

(30) Foreign Application Priority Data
Jun. 18, 2020 (JP) 2020-105135

(51) Int. Cl. G06F 1/20; G05B 15/02; G05D 23/19

(52) U.S. Cl. CPC G06F 1/206; G05D 23/1917; G05B 15/02

(57) ABSTRACT

A temperature control device that is mounted on an information processing apparatus together with a temperature sensor, a fan, and a plurality of coupling parts that enable coupling of an expansion device, and that controls a temperature of the information processing apparatus, the temperature control device includes: a memory; and a processor coupled to the memory and configured to: hold, in the memory, a profile that indicates a relationship between a temperature of the information processing apparatus and rotational speed of the fan for each position of the coupling part to which the expansion device is coupled; receive, via a basic input and output program that operates exclusively with respect to an operating system, a profile for new expansion device received by the operating system when a driver for controlling a new expansion device newly mounted in the coupling part is installed in the information processing apparatus.

### CROSS-REFERENCE TO RELATED APPLICATION

This application is based upon and claims the benefit of priority of the prior Japanese Patent Application No. 2020-105135, filed on Jun. 18, 2020, the entire contents of which are incorporated herein by reference.

### FIELD

The embodiments discussed herein are related to a temperature control device, an information processing apparatus, and a temperature control method.

### BACKGROUND

In a common server apparatus, a temperature sensor and a fan are mounted for cooling electronic components mounted on a motherboard or the like. When a temperature acquired from the temperature sensor exceeds a threshold, a management device that manages a power source or the like of the server apparatus increases the rotational speed of the fan to enhance the capability of cooling the inside of a housing.

Related art is disclosed in Japanese Laid-open Patent Publication No. 2019-133635) and Japanese Laid-open Patent Publication No. 2007-149082)

### SUMMARY

According to an aspect of the embodiments, a temperature control device that is mounted on an information processing apparatus together with a temperature sensor, a fan, and a plurality of coupling parts that enable coupling of an expansion device, and that controls a temperature of the information processing apparatus, the temperature control device includes: a memory; and a processor coupled to the memory and configured to: hold, in the memory, a profile that indicates a relationship between a temperature of the information processing apparatus and rotational speed of the fan for each position of the coupling part to which the expansion device is coupled; receive, via a basic input and output program that operates exclusively with respect to an operating system, a profile for new expansion device received by the operating system when a driver for controlling a new expansion device newly mounted in the coupling part is installed in the information processing apparatus; add the profile to the memory; select one of a plurality of profiles held in the memory in accordance with an expansion device coupled to the coupling part detected by the basic input and output program; and control rotational speed of a fan based on a temperature detected by the temperature sensor by using a selected profile.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of an information processing apparatus including a temperature control device according to an embodiment;

FIG. 2 is a sequence diagram illustrating an example of the operation of the information processing apparatus in FIG. 1;

FIG. 3 is a block diagram illustrating an example of a server apparatus including a temperature control device according to another embodiment;

FIG. 4 is a block diagram illustrating an example of a board layout of the server apparatus in FIG. 3;

FIG. 5 is an explanatory diagram illustrating an example of card configuration information held by a profile holding unit in FIG. 3;

FIG. 6 is an explanatory diagram illustrating an example of rotational speed information held by the profile holding unit in FIG. 3;

FIG. 7 is an explanatory diagram illustrating an example of characteristic information held by the profile holding unit in FIG. 3;

FIG. 8 is an explanatory diagram illustrating an example of a graph indicating the characteristic included in the characteristic information in FIG. 7;

FIG. 9 is a flowchart illustrating an example of the operation of a BMC in FIG. 3;

FIG. 10 is an explanatory diagram illustrating an example of a display function of characteristic information in FIG. 3;

FIG. 11 is a sequence diagram illustrating an example of the operation of the server apparatus in FIG. 3;

FIG. 12 is a sequence diagram illustrating another example of the operation of the server apparatus in FIG. 3;

FIG. 13 is a sequence diagram illustrating still another example of the operation of the server apparatus in FIG. 3;

FIG. 14 is an explanatory diagram illustrating another example of the card configuration information held by the profile holding unit in FIG. 3; and

FIG. 15 is an explanatory diagram illustrating still another example of the card configuration information held by the profile holding unit in FIG. 3.

### DESCRIPTION OF EMBODIMENTS

For example, the management device classifies electronic components mounted on the server apparatus into a plurality of levels and controls power to be supplied to the fan for each level. The server apparatus acquires a profile for determining the rotational speed of the fan based on a change in components arranged in the housing.

Normally, cooling control for the entire server apparatus is performed by acquiring, with the temperature sensor, a temperature of a central processing unit (CPU) having an amount of generated heat larger than those of other mounted components, and applying the acquired temperature to a profile to control the rotational speed of the fan. However, for example, when an expansion card generating a large amount of heat is mounted in the server apparatus, it may be difficult to suppress an increase in temperature of the expansion card only by controlling the rotational speed of the fan based on the monitoring of temperature mainly for the CPU.

In order to suppress an increase in temperature of the expansion card, for example, a profile is created in consideration of the mounting position of the expansion card in the server apparatus, the combination of the expansion cards, or the like, and the profile is applied by updating firmware. However, it is not realistic to apply a profile corresponding to a new expansion card by updating firmware every time the new expansion card is supported, because development cost and maintenance cost of the server apparatus increase.

In one aspect, an increase in cost for setting, in an information processing apparatus, a profile for cooling control corresponding to an expansion device mounted in the information processing apparatus may be minimized.

Hereinafter, embodiments will be described with reference to the drawings.

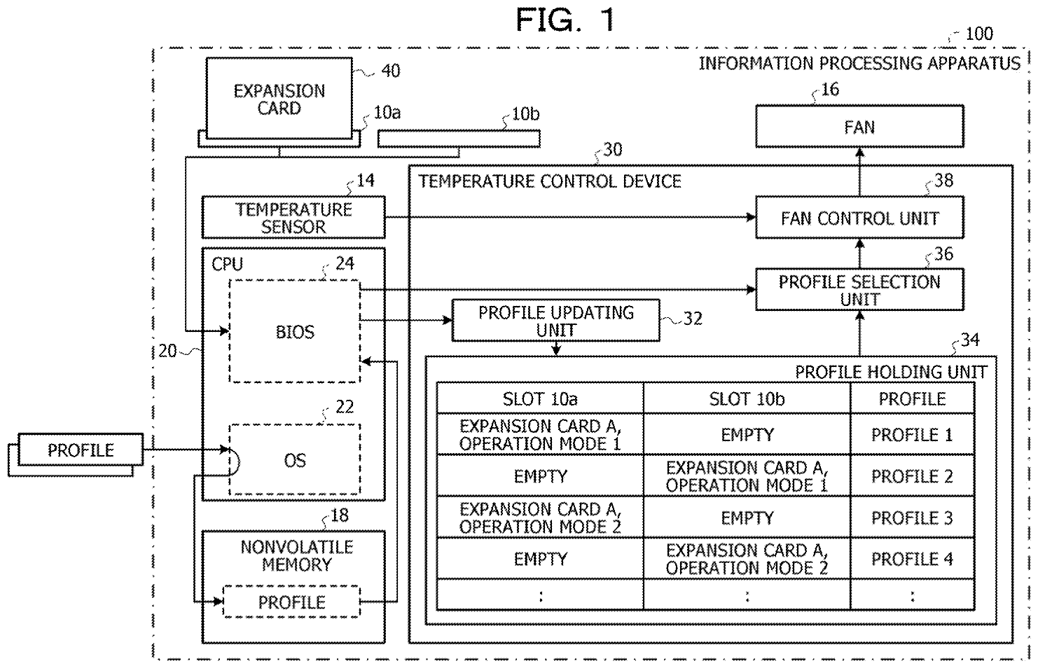

FIG. 1 illustrates an example of an information processing apparatus including a temperature control device according to an embodiment. An information processing apparatus 100 illustrated in FIG. 1 is, for example, a server apparatus, and includes a plurality of slots 10 (10a, 10b), a temperature sensor 14, a fan 16, a nonvolatile memory 18, a CPU 20, and a temperature control device 30. For example, the plurality of slots 10, the temperature sensor 14, the fan 16, the nonvolatile memory 18, the CPU 20, and the temperature control device 30 are mounted on a motherboard housed in a housing (not illustrated) of the information processing apparatus 100.

Multiple types of expansion cards 40, such as Peripheral Component Interconnect (PCI) cards, may be coupled to each slot 10 (card slot) Each slot 10 is an example of a coupling unit. The expansion card 40 is an example of an expansion device. The number of slots 10 may be three or more. Although the expansion card 40 is described as an example of an expansion device in this embodiment, the expansion device may be a disk such as a hard disk drive (HDD) or a solid-state drive (SSD) or a memory such as a dual inline memory module (DIMM).

The temperature sensor 14 measures the temperature in the housing of the information processing apparatus 100. The fan 16 operates to discharge, to the outside, the air in the housing that rises due to the heat generated by components such as the CPU 20 mounted on the motherboard, and lower the temperature in the housing. The nonvolatile memory 18 is, for example, an electrically rewritable memory such as a flash memory, and is allocated to a memory space accessible by an operating system 22 and a Basic Input/Output System (BIOS) 24 (firmware).

The expansion card 40 may include a plurality of operation modes with power consumptions different from each other. For example, processing performance such as a data transfer rate or a data processing amount is higher and an amount of generated heat is larger in an operation mode with high power consumption than in an operation mode with low power consumption.

The CPU 20 performs each of the functions of the operating system 22 and the BIOS 24 stored in a memory (not illustrated) by causing the operating system 22 and the BIOS 24 to operate exclusively. The operating system 22 and the BIOS 24 are stored as programs in the memory (not illustrated), Hereinafter, the operating system 22 is also referred to as the OS 22. The CPU 20 is an example of a processor, and the BIOS 24 is an example of a basic input and output program.

The OS 22 controls the operation of application programs executed by the CPU 20, For example, the OS 22 receives, from the outside of the information processing apparatus 100, a profile for a new expansion card 40, which is the expansion card 40 to be newly inserted in the slot 10, based on an instruction from a user of the information processing apparatus 100. The OS 22 stores the received profile in the nonvolatile memory 18. The new expansion card 40 is an example of a new expansion device.

For example, the profile includes, for each combination of identification information for identifying the expansion card 40 and the position of the slot 10 to which the expansion card 40 is coupled, characteristic information (information on control curve) indicating the relationship between the temperature measured by the temperature sensor 14 and the rotational speed of the fan 16. When the expansion card 40 includes a plurality of operation modes, the profile may include an operation mode of the expansion card 40.

The BIOS 24 is started when the information processing apparatus 100 is powered on. The BIOS 24 executes initialization and the like of hardware mounted on the information processing apparatus 100, loads the OS 22 into the memory (not illustrated), and enables the OS 22 to be executed. When the BIOS 24 is restarted based on an instruction from the OS 22, the BIOS 24 transfers the profile for the new expansion card 40 from the nonvolatile memory 18 to the temperature control device 30. When the information processing apparatus 100 is powered on and when the BIOS 24 is reactivated based on an instruction from the OS 22, the BIOS 24 reads device information (card information) from the expansion card 40 inserted in the slot 10 and notifies the temperature control device 30 of the read device information.

The temperature control device 30 includes a profile updating unit 32, a profile holding unit 34, a profile selection unit 36, and a fan control unit 38. For example, the temperature control device 30 is included in a management device such as a baseboard management controller (BMC) that manages the operation of the CPU 20 and the fan 16. While power is supplied to the information processing apparatus 100, the management device such as the BMC continues to operate regardless of whether power is supplied to the CPU 20.

The profile updating unit 32 stores, in the profile holding unit 34, the profile for the new expansion card 40 transferred from the outside of the information processing apparatus 100 via the OS 22 and the BIOS 24. The profile holding unit 34 holds a profile indicating a relationship between the temperature of the information processing apparatus 100 measured by the temperature sensor 14 and the rotational speed of the fan 16 for each position of the slot 10 to which the expansion card 40 is coupled.

The profile holding unit 34 may hold different profiles for different operation modes of the expansion card 40 inserted in the slot 10. In the example illustrated in FIG. 1, the profile holding unit 34 holds profiles of an expansion card A among the multiple types of expansion cards 40 which may be inserted in the slot 10, in association with two operation modes 1 and 2 and the slots 10a, 10b in which the expansion card 40 is inserted. The profile holding unit 34 holds a default profile that does not depend on the expansion card 40 inserted in the slot 10.

The profile selection unit 36 reads, from the profile holding unit 34, a profile corresponding to the expansion card 40 inserted in the slot 10 based on the device information notified by the BIOS 24, and outputs the read profile to the fan control unit 38.

The fan control unit 38 uses the profile (information on control curve indicating the relationship between the temperature and the rotational speed of the fan 16) received from the profile selection unit 36 to provide the fan 16 with rotational speed information indicating the rotational speed corresponding to the temperature received from the temperature sensor 14. The fan 16 rotates at the rotational speed corresponding to the rotational speed information provided by the fan control unit 38. For example, the rotational speed of the fan 16 increases as the temperature measured by the temperature sensor 14 increases. Information on control curve included in a profile varies depending on the type of the expansion card 40 inserted in the slot 10 and the position of the slot 10 in which the expansion card 40 is inserted. Control curves for rotational speed may vary depending on the operation mode of the expansion card 40.

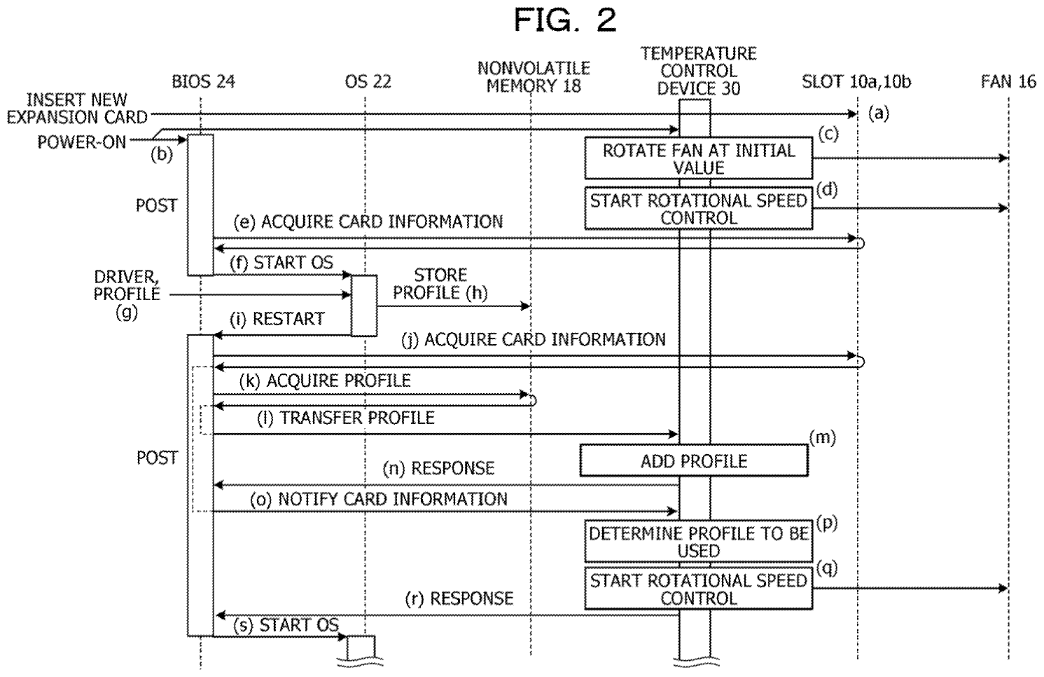

FIG. 2 illustrates an example of the operation of the information processing apparatus 100 in FIG. 1. FIG. 2 illustrates an example of a temperature control method for the information processing apparatus 100 by the temperature control device 30. In the example illustrated in FIG. 2, the new expansion card 40 is coupled to one of the slots 10a, 10b, a profile corresponding to the new expansion card 40 is stored in the profile holding unit 34 of the temperature control device 30, and temperature control for the new expansion card 40 is executed.

First, the new expansion card 40 is coupled to one of the slots 10 ((a) in FIG. 2). Next, power is supplied to the CPU 20 (power-on; (b) in FIG. 2). After causing the fan 16 to rotate at an initial value based on power-on of the CPU 20, the temperature control device 30 starts controlling the rotational speed of the fan 16 in accordance with the temperature measured by the temperature sensor 14 ((c) and (d) in FIG. 2).

When the profile of the expansion card 40 inserted in the slot 10 is held by the profile holding unit 34, the temperature control device 30 starts controlling the rotational speed of the fan 16 by using the profile (information on control curve) of the expansion card 40 inserted in the slot 10. In the example illustrated in FIG. 2, since the profile of the new expansion card 40 is not held in the profile holding unit 34, the temperature control device 30 starts controlling the rotational speed of the fan 16 by using a default profile.

The BIOS 24 is started in response to power-on of the CPU 20, The BIOS 24 executes power-on self-test (POST), and acquires card information stored in the expansion card 40 coupled to the slot 10 and position information of the slot 10 to which the expansion card 40 is coupled ((e) in FIG. 2). When the expansion card 40 includes a plurality of operation modes, the BIOS 24 may acquire, from the expansion card 40, an operation mode to be used in an initial state.

In this embodiment, when the profile corresponding to the expansion card 40 inserted in the slot 10 is not held in the profile holding unit 34, the temperature control device 30 starts controlling the rotational speed of the fan 16 without notifying the BIOS 24 of an error. This may suppress the BIOS 24 from stopping the starting process by POST and notifying the host system of the error. Thus, even when the expansion card 40 unknown to the temperature control device 30 is inserted in the slot 10, a system error may be suppressed from occurring.

Next, the BIOS 24 starts the OS 22, and then terminates the operation ((f) in FIG. 2). The OS 22 starts controlling the operation of application programs. After that, the OS 22 receives a driver and a profile corresponding to the new expansion card 40 transferred from the outside based on the operation of the information processing apparatus 100 by the user of the information processing apparatus 100 ((g) in FIG. 2), The OS 22 installs the received driver and stores the received profile in the nonvolatile memory 18 ((h) in FIG. 2). The OS 22 restarts the BIOS 24 with the reception of a new profile as a starting factor ((i) in FIG. 2).

For example, the profile stored in the nonvolatile memory 18 is similar to the profile indicated in the profile holding unit 34 of FIG. 1, and includes a profile (information on control curve) for each combination of an operation mode of the new expansion card 40 and a position at which the new expansion card is inserted in the slot 10. When there is only one operation mode for the expansion card 40, a profile for each position at which the expansion card is inserted in the slot 10 is stored in the nonvolatile memory 18.

The restarted BIOS 24 executes POST, and acquires card information held in the new expansion card 40 coupled to the slot 10 and position information of the slot 10 to which the new expansion card 40 is coupled (0) in FIG. 2). The BIOS 24 may acquire the operation mode of the expansion card 40. Since the starting factor of the BIOS 24 is the reception of a new profile, the BIOS acquires the profile held in the nonvolatile memory 18 ((k) in FIG. 2).

The BIOS 24 transfers the acquired profile to the temperature control device 30 ((I) in. FIG. 2). The profile updating unit 32 of the temperature control device 30 adds the received profile to the profile holding unit 34 ((m) in FIG. 2). For example, the profile updating unit 32 updates the profile holding unit 34 in accordance with the newly coupled expansion card 40. The temperature control device 30 returns, to the BIOS 24, a response to the reception of the profile ((n) in FIG. 2).

Based on the response from the temperature control device 30, the BIOS 24 notifies the temperature control device 30 of the card information (including the position information of the slot 10) of the new expansion card 40 ((o) in FIG. 2), The BIOS 24 may notify the temperature control device 30 of the operation mode of the expansion card 40.

The profile selection unit 36 of the temperature control device 30 searches the profile holding unit 34 based on the card information received from the BIOS 24, and determines the use of a profile corresponding to the received card information ((p) in FIG. 2). The profile selection unit 36 notifies the fan control unit 38 of the determined profile (information on control curve). The fan control unit 38 starts controlling the rotational speed of the fan 16 by using the notified profile ((q) in FIG. 2). The temperature control device 30 returns, to the BIOS 24, a response to the reception of the card information ((r) in. FIG. 2). The BIOS 24 having received the response starts the OS 22, and then terminates the operation ((s) in FIG. 2).

As described above, in the embodiment illustrated in FIGS. 1 and 2, the profile for controlling the rotational speed of the fan 16 is held not in the BIOS 24 but in the profile holding unit 34 of the temperature control device 30. The temperature control device 30 is notified of the profile stored in the profile holding unit 34 via the OS 22 and the BIOS 24. Thus, the temperature control device 30 may acquire the profile corresponding to the new expansion card 40 without updating the BIOS 24 (firmware). When the temperature control device 30 operates on firmware, the temperature control device 30 may acquire the profile corresponding to the new expansion card 40 without updating the firmware.

As a result, an increase in development cost and work cost far updating the firmware may be minimized, and control of the rotational speed of the fan 16 optimized for the new expansion card 40 may be achieved in the shipped information processing apparatus 100. Thus, the rotational speed of the fan 16 may be controlled appropriately for the new expansion card 40, and a situation may be suppressed where the temperature in the housing of the information processing apparatus 100 locally exceeds the temperature specification.

The profile is transferred from the OS 22 to the BIOS 24 via the nonvolatile memory 18 allocated to a memory space accessible by the OS 22 and the BIOS 24. Thus, the profile may be transferred between the OS 22 and the BIOS 24 operating in a mutually exclusive manner, and the BIOS 24 may transfer the acquired profile to the temperature control device 30. The transfer of a profile to the temperature control device 30 may be achieved by providing the BIOS 24 with a function of acquiring the profile from the nonvolatile memory 18 and transferring the profile to the temperature control device 30 when the starting factor is the reception of a new profile. For example, by using the nonvolatile memory 18, and the BIOS 24 is restarted after the OS 22 is started based on power-on of the CPU 20, a profile received by the OS 22 may be transferred to the temperature control device 30 via the BIOS 24.

When the profile corresponding to the expansion card 40 inserted in the slot 10 is not held in the profile holding unit 34, the temperature control device 30 starts controlling the rotational speed of the fan 16 by using a default profile without notifying the BIOS 24 of an error. This may suppress the BIOS 24 from stopping the starting process by POST and notifying the host system of the error, Thus, even when the expansion card 40 unknown to the temperature control device 30 is inserted in the slot 10, a system error may be suppressed from occurring.

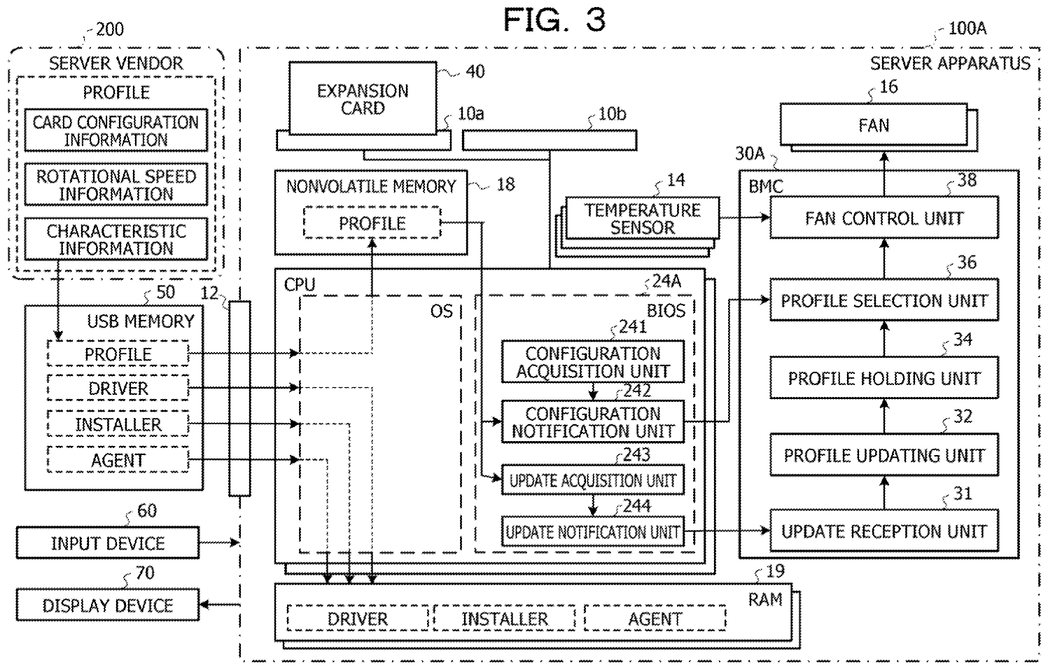

FIG. 3 illustrates an example of a server apparatus including a temperature control device according to another embodiment. Elements similar to those illustrated in FIG. 1 are indicated by the same reference numerals, and detailed description is omitted for such elements. A server apparatus 100A illustrated in FIG. 3 includes a plurality of slots 10 (10a and 10b), a Universal Serial Bus (USB) interface 12, a plurality of temperature sensors 14, a plurality of fans 16, a nonvolatile memory 18, a plurality of random-access memories (RAM) 19, a CPU 20, and a BMC 30A. The server apparatus 100A is an example of an information processing apparatus, and the USB interface 12 is an example of an input and output interface. The BMC 30A includes a temperature control device, and is an example of a management device that manages the operation of the server apparatus 100A and the CPU 20.

The server apparatus 100A includes an input interface (not illustrated) to which an input device 60 such as a keyboard or a mouse is coupled and an output interface (not illustrated) to which a display device 70 such as a liquid crystal display is coupled. In FIG. 3, a frame of a dashed line indicating the server apparatus 100A indicates, for example, a housing or a motherboard. Also in this embodiment, an example in which an expansion device is an expansion card 40 is described, but the expansion device may be a disk such as HDD or SSD, or a memory such as DIMM (for example, the RAM 19).

The CPU 20 exclusively executes an OS 22 and a BIOS 24A stored in the RAM 19, and executes various programs such as an installer and an agent during the execution of the OS 22. For example, the OS 22 downloads a profile, a driver, an installer, and an agent for the expansion card 40 from a USB memory 50 coupled to the USB interface 12. The profile includes information for controlling the rotational speed of the fan 16 in accordance with the temperature measured by the temperature sensor 14 in consideration of the heat generation characteristics of the expansion card 40 inserted in the slot 10. The USB memory 50 is an example of a recording medium. The profile, the driver, the installer, and the agent may be downloaded from a recording medium such as a compact disc read-only memory (CD-ROM) or a Digital Versatile Disc (DVD) (registered trademark).

The OS 22 stores the downloaded profile in the nonvolatile memory 18 and stores the downloaded driver, installer, and agent in the RAM 19. The OS 22 executes downloading of various files from the USB memory 50 based on an instruction received from a user of the server apparatus 100A via the input device 60. The nonvolatile memory 18 is allocated to a memory space accessible by the OS 22 and the BIOS 24A.

The profile is created by a server vendor 200 that develops or manufactures the server apparatus 100A in a case where the server vendor 200 supports the new expansion card 40. For example, the profile includes card configuration information, rotational speed information, and characteristic information (performance characteristics and power characteristics), In the card configuration information, for each of the slot 10 in which the expansion card 40 is inserted and the operation mode of the expansion card 40, a control curve to be used is defined, among a plurality of control curves for rotational speed included in the rotational speed information.

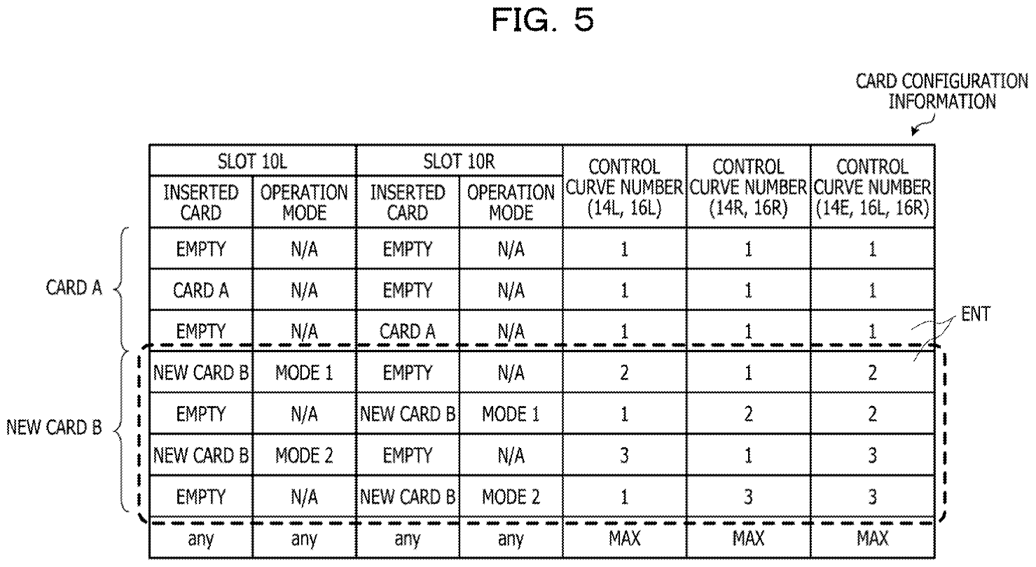

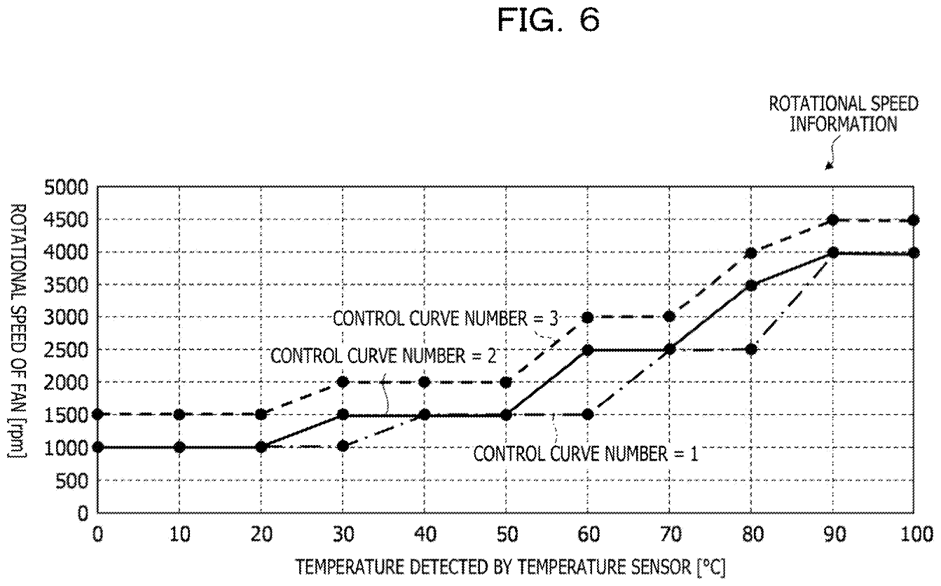

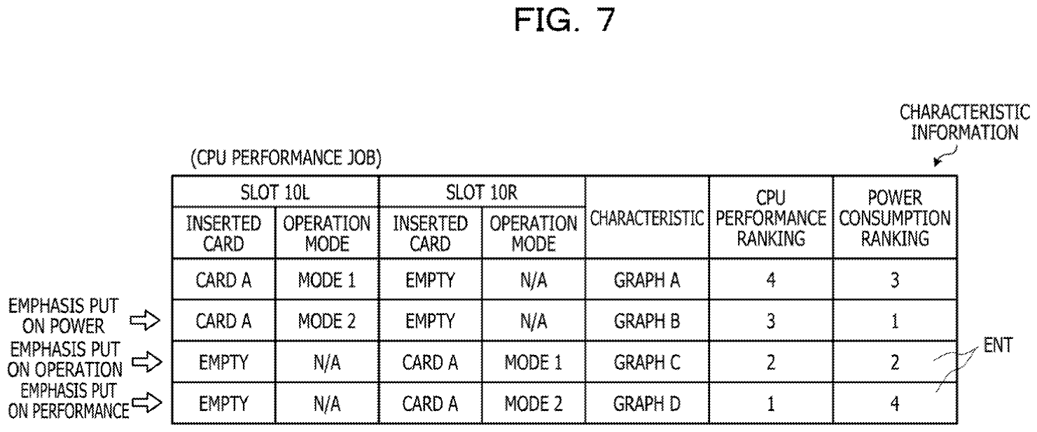

Multiple patterns of control curves indicating the relationship between the temperature and the rotational speed of the fan 16 are defined in the rotational speed information. The characteristic information is created from results of executing a benchmark test (CPU performance and network performance) on the server apparatus 100A, which is executed for each of mounting specifications such as the card configuration information, used CPU 20, and the number of mounted RAMs 19. In the characteristic information, CPU performance ranking and power consumption ranking evaluated based on the benchmark test are defined for each mounting specification. An example of the card configuration information is illustrated in FIG. 5, an example of the rotational speed information is illustrated in FIG. 6, and an example of the characteristic information is illustrated in FIG. 7.

The BIOS 24A includes a configuration acquisition unit 241, a configuration notification unit 242, an update acquisition unit 243, and an update notification unit 244. The configuration acquisition unit 241 acquires card information (including operation mode) held in the expansion card 40 coupled to the slot 10 and position information of the slot 10 to which the expansion card 40 is coupled, and outputs the acquired card information and position information to the configuration notification unit 242.

The configuration notification unit 242 notifies the profile selection unit 36 of the card information and position information received from the configuration acquisition unit 241. The configuration notification unit 242 notifies the profile selection unit 36 of information indicating a change in the operation mode of the expansion card 40 received via the nonvolatile memory 18.

The update acquisition unit 243 acquires the profile held in the nonvolatile memory 18 and outputs the acquired profile to the update notification unit 244. The update notification unit 244 notifies an update reception unit 31 of the profile received from the update acquisition unit 243. For example, communication between the BIOS 24A and the BMC 30A is executed using an Intelligent Platform Management. Interface (IPMI).

The BMC 30A includes the update reception unit 31 in addition to the configuration of the temperature control device 30 illustrated in FIG. 1. A profile updating unit 32, a profile holding unit 34, a profile selection unit 36, and a fan control unit 38 have the same functions as the profile updating unit 32, the profile holding unit 34, the profile selection unit 36, and the fan control unit 38 illustrated in FIG. 1, respectively. For example, the update reception unit 31, the profile updating unit 32, the profile holding unit 34, the profile selection unit 36, and the fan control unit 38 are included in the temperature control device in the BMC 30A. The temperature control device may be enabled by firmware of the BMC 30A or may be enabled by hardware.

The update reception unit 31 transfers the profile received from the update notification unit 244 of the BIOS 24A to the profile updating unit 32. The profile updating unit 32 stores the transferred profile in the profile holding unit 34. Based on the card information and position information notified from the configuration notification unit 242 of the BIOS 24A, the profile selection unit 36 reads, from the profile holding unit 34, the profile corresponding to the expansion card 40 inserted in the slot 10.

Based on the notification of a change in the operation mode of the expansion card 40 from the configuration notification unit 242, the profile selection unit 36 reads a profile corresponding to the notified operation mode from the profile holding unit 34. The profile selection unit 36 outputs the read profile to the fan control unit 38. By using the profile received from the profile selection unit 36, the fan control unit 38 controls the rotational speed of the fan 16 based on the temperature received from the temperature sensor 14.

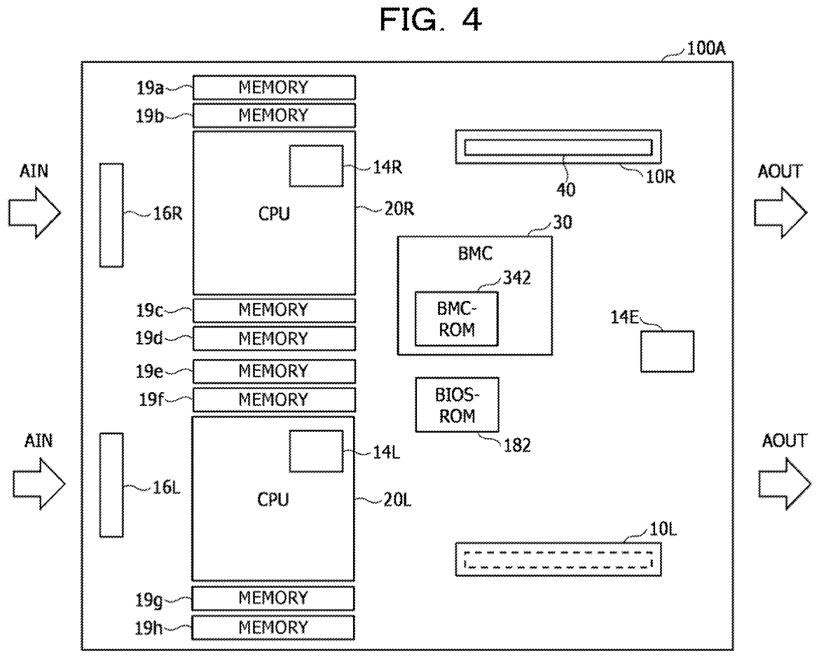

FIG. 4 illustrates an example of a board layout of the server apparatus 100A in FIG. 3, The board layout of the server apparatus 100A, the number of the fans 16, the number of the slots 10, and the number of the memories 19 are not limited to those in the example illustrated in FIG. 4.

An outer frame of the server apparatus 100A illustrated in FIG. 4 indicates a motherboard. On the motherboard, two fans 16 (16R, 160 are arranged at an interval on an air inflow side AIN, and the CPUs 20 (20R, 20L) are arranged on a downstream side facing the fans 16. The temperature sensor 14 (14R, 14L) is attached over the package of each CPU.

Eight memories 19 (19a to 19h) are arranged in areas adjacent to the CPUs 20 in a direction perpendicular to the air flow direction. For example, each of the memories 19 is a memory module such as DIMM, and is attached to the motherboard along the air flow direction. Each of the memories 19 is removably attached to the motherboard via a memory slot (not illustrated) secured over the motherboard.

On the motherboard, the BMC 30A including a BMC-ROM 342, a BIOS-ROM 182, two slots 10 (10R, 10L), and a temperature sensor 14E are arranged on a downstream side of the CPUs 20. For example, the BMC-ROM 342 is a flash memory, and includes the profile holding unit 34 in FIG. 3 and BMC firmware. For example, the BIOS-ROM 182 corresponds to the nonvolatile memory 18 in FIG. 3. The slots 10R, 10L correspond to the slots 10a, 10b in FIG. 3.

In FIG. 4, the expansion card 40 is coupled to the slot 10R. However, the expansion card 40 may be coupled to the slot 10L. Each of the slots 10R, 10L is attached to the motherboard along the air flow direction. The temperature sensor 14E is arranged on the motherboard near an air outflow side AOUT.

In the board layout illustrated in FIG. 4, for example, the BMC 30A increases the rotational speed of the fan 16R as the temperature detected by the temperature sensor 14R is higher, and increases the rotational speed of the fan 16L as the temperature detected by the temperature sensor 14L is higher. When the temperature sensor 14E detects a temperature equal to or higher than a predetermined value, the BMC 30A increases the rotational speed for both of the fans 16R, 16L.

Since the slots 10 are located farther from the temperature sensors 14 compared to the CPUs 20, it is difficult for the temperature sensors 14R, 14L, 14E to directly measure the temperatures of the expansion cards 40 coupled to the slots 10. Thus for example, when the expansion card 40 including a plurality of operation modes is coupled to the slot 10 and operates in an operation mode with high power consumption, the rotational speed of the fan 16 may not increase even when the temperature of the expansion card 40 increases. In this case, the expansion card 40 may not be appropriately cooled.

There is a case where data transfer executed in the server apparatus 100A is executed only by the function of the expansion card 40 without using the function of the CPU 20. In this case, even when the rotational speed of the fan 16 is controlled based on the temperature measured by each temperature sensor 14, it may be difficult to keep the temperature in the housing within the temperature specification, and the temperature around the expansion card 40 may locally increase.

In this embodiment, the BMC 30A changes a control curve indicating the relationship between the temperature detected by the temperature sensor 14 and the rotational speed of the fan 16 in accordance with the power consumption characteristics of the expansion card 40 and the position of the slot 10 in which the expansion card 40 is inserted. For example, the power consumption characteristics of the expansion card 40 vary depending on the operation mode of the expansion card 40.

In this embodiment, in a case where the expansion card 40 newly installed on the server apparatus 100A is supported, an optimum control curve may be set in the BMC 30A without updating the BIOS 24A and the firmware of the BMC 30A. As a result, development cost and maintenance cost for updating the BIOS 24A and the firmware of the BMC 30A may be reduced.

In this embodiment, a graph indicating a currently applied control curve and a graph indicating a control curve of a case where the operation mode or the inserted slot 10 is changed, may be displayed on the display device 70. For example, control curves are displayed on the display device 70 when the operation mode is changed or when a display request from the user of the server apparatus 100A is received. This may reduce time and effort for the user of the server apparatus 100A to determine the inserting position, the operation mode, and the like of the expansion card 40 by trial and error, and may reduce time to start operation of the server apparatus 100A using the new expansion card 40.

FIG. 5 illustrates an example of the card configuration information held by the profile holding unit 34 in FIG. 3. The profile holding unit 34 includes, for each type of the expansion card 40 (card A or new card B), a plurality of entries ENT for different positions of the slot 10L (or 10R) in which the card is inserted and different operation modes of the expansion card 40. The card configuration information is held in each entry ENT.

The operation mode “N/A” in each entry ENT indicates that the operation mode is not switchable because there is only one operation mode. “any” stored in the inserted card field and the operation mode field of each entry ENT indicates that the inserted card or the operation mode may be anything.

In each entry ENT, for each combination of the temperature sensor 14 and the fan 16, a control curve number (for example, any of 1, 2, and 3) used for control by the BMC 30A is stored. An example of control curves respectively corresponding to the control curve numbers is illustrated in FIG. 6. “MAX” indicated in the control curve number field indicates that the rotational speed of the fan 16 is set to the maximum regardless of the temperature detected by the temperature sensor 14.

Four entries ENT indicated by a thick broken line frame indicate card configuration information of the new card B that is newly supported. The card configuration information of the new card B (four entries ENT) is card configuration information created when the server vendor 200 in FIG. 3 supports the new card B.

The card configuration information of the new card B created by the server vendor 200 is stored in the USB memory 50 as part of the profile for controlling the fan 16, and is transferred from the USB memory 50 to the nonvolatile memory 18 by the OS 22. The card configuration information of the new card B acquired from the nonvolatile memory 18 by the BIOS 24A is transferred to the BMC 30A and stored in the profile holding unit 34. FIG. 5 illustrates an example in which the card configuration information of the new card B is added to the card configuration information of the original card A.

FIG. 6 illustrates an example of rotational speed information held by the profile holding unit 34 in FIG. 3. The rotational speed information includes information indicating the rotational speed of the fan 16 for the temperature detected by the temperature sensor 14 for each control curve number in FIG. 6. In FIG. 6, the rotational speed information is illustrated in a graph for easy understanding, but the rotational speed information has only to include information on the temperature and rotational speed for each control curve number.

The rotational speed information illustrated in FIG. 6 is created each time the new expansion card 40 is supported by the server vendor 200, and is stored as a profile in the USB memory 50 together with the card configuration information. The rotational speed information is stored in the profile holding unit 34 together with the card configuration information.

The profile holding unit 34 may hold the rotational speed information illustrated in FIG. 6 for each expansion card 40 or may hold rotational speed information common to the multiple types of expansion cards 40. The common rotational speed information indicates that, for example, when the rotational speed information includes 20 control curves corresponding to the control curve numbers of 1 to 20, three out of the 20 control curve numbers are stored in the card configuration information illustrated in FIG. 5. When the profile holding unit 34 holds the common rotational speed information, information on control curve that is used for the new expansion card 40 and is not held by the profile holding unit 34, is transferred to the BMC 30A together with the card configuration information.

FIG. 7 illustrates an example of characteristic information held by the profile holding unit 34 in FIG. 3. The characteristic information includes, for each expansion card 40, a plurality of entries ENT for different positions of the slot 10L (or 10R) in which the card is inserted and different operation modes. In each entry ENT, information indicating characteristic, CPU performance ranking, and power consumption ranking is stored.

Each time the new expansion card 40 is supported, the characteristic, CPU performance ranking, and power consumption ranking are set by the server vendor 200 installing the new expansion card 40 in a server apparatus for evaluation and executing a benchmark test.

The set characteristic, CPU performance ranking, and power consumption ranking are incorporated in the characteristic information. The created characteristic information is stored as a profile in the USB memory 50 together with the card configuration information and the rotational speed information. The characteristic information is stored in the profile holding unit 34 together with the card configuration information and the rotational speed information. Together with the characteristic information, information indicating the characteristics (graphs A to D) in FIG. 7 is stored in the profile holding unit 34 via the USB memory 50.

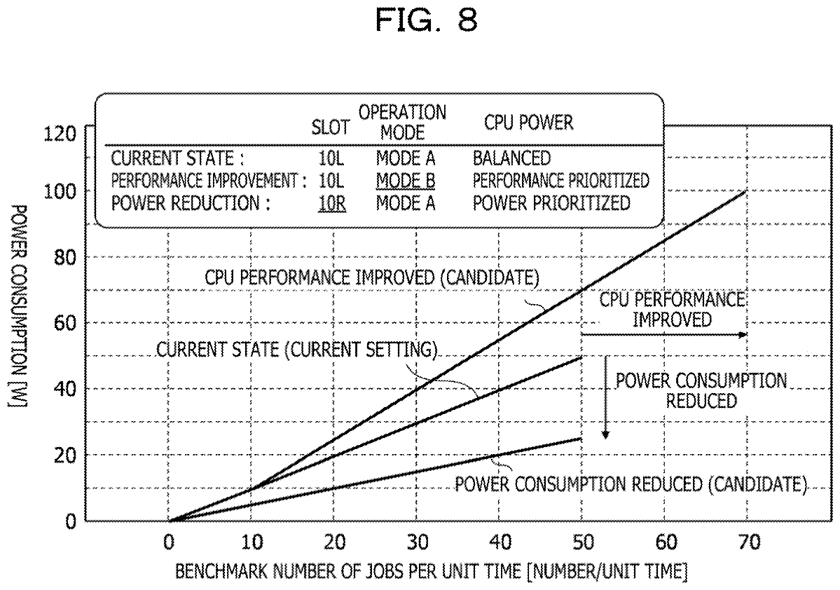

In the characteristic field, for each entry ENT, information indicating a graph representing a relationship between power consumption and the number of jobs that may be executed per unit time, is stored. An example of a graph indicating the characteristic is illustrated in FIG. 8. The CPU performance ranking and power consumption ranking indicate ranking obtained from a benchmark test by the server vendor 200. In the CPU performance ranking, smaller number indicates higher performance. In the power consumption ranking, smaller number indicates lower power consumption.

For example, when emphasis is put on power (low power consumption), it is preferable that the position of the slot 10L (or 10R) for inserting the expansion card 40 and the operation mode be set in the second entry ENT from the top. When emphasis is put on CPU performance (high performance), it is preferable that the position of the slot 10L (or 10R) for inserting the expansion card 40 and the operation mode be set in the lowermost entry ENT. When emphasis is put on the easiness of operation, it is preferable that the position of the slot 10L (or 10R) for inserting the expansion card 40 and the operation mode be set in the third entry ENT from the top.

FIG. 8 illustrates an example of a graph indicating the characteristic included in the characteristic information in FIG. 7. The characteristic indicates a relationship between the number of jobs executed per unit time and power consumption. For example, the graph illustrated in FIG. 8 is displayed on the display device 70 by the agent executed by the OS 22 based on a request from the user of the server apparatus 100A.

For example, when a display request of a graph indicating the characteristic is made, the BMC 30A acquires, from the profile holding unit 34, information on three performance curves respectively indicating the current state (current setting of the expansion card 40), a case where CPU performance is improved, and a case where power consumption is reduced. The BMC 30A transfers the acquired information on three performance curves to the BIOS 24A, and the BIOS 24A stores the transferred information in the nonvolatile memory 18. The agent displays the graph illustrated in FIG. 8 on the display device 70 by using the information stored in the nonvolatile memory 18.

The graph illustrated in FIG. 8 indicates that, when the current setting is changed to improve performance of the CPU 20, the number of jobs that may be executed per unit time increases by 20. The graph also indicates that, when the current setting is changed to reduce power consumption, power consumption is reduced by 25 W.

By displaying the graph indicating the characteristic on the display device 70, the user of the server apparatus 100A may check an approximate change in performance without changing the operation mode and the position of the slot 10 in which the expansion card 40 is inserted. For example, the user may change the operation mode and the position of the slot 10 in which the expansion card 40 is inserted, and acquire a graph indicating the characteristic without actually executing jobs and evaluating CPU performance and power consumption. As a result, it is possible to reduce the work time (for example, cost) for checking the optimum configuration of the expansion card 40 to be newly inserted, compared with the case where jobs are executed to make an evaluation.

Information in the upper left frame in the graph in FIG. 8 indicates the feature of each performance curve, and the underlined portions indicate items whose setting is to be changed from the current state. The information in the upper left frame in the graph may not be displayed on the display device 70.

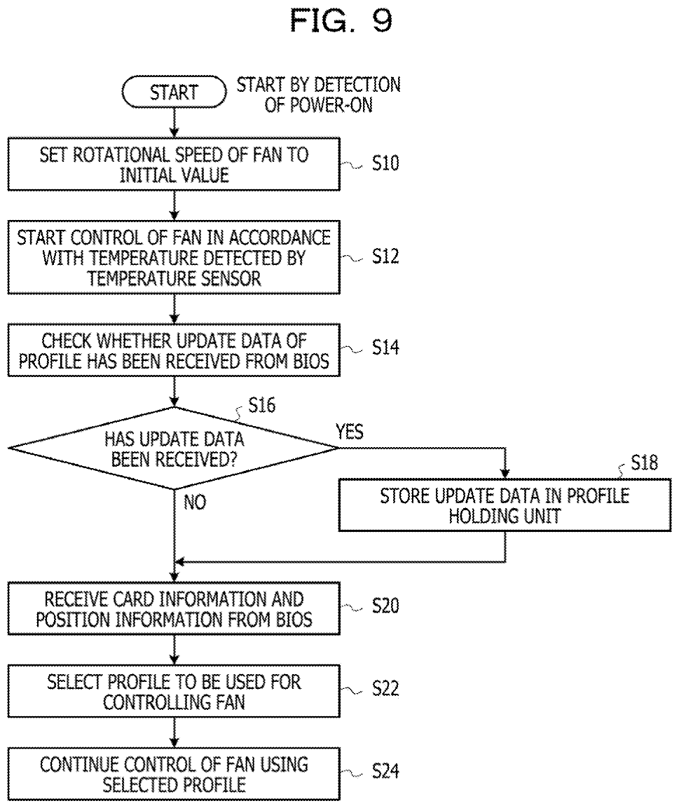

FIG. 9 illustrates an example of the operation of the BMC 30A in FIG. 3. FIG. 9 illustrates an example of a temperature control method for the server apparatus 100A by the BMC 30A. For example, the operation illustrated in FIG. 9 is executed by the firmware of the BMC 30A when power-on of the CPU 20 is detected.

First, in step S10, the fan control unit 38 of the BMC 30A sets the rotational speed of each fan 16 to an initial value. Next, in step S12, the fan control unit 38 starts controlling the rotational speed of each fan 16 in accordance with the temperature detected by each temperature sensor 14. Immediately after the power-on of the CPU 20, the BMC 30A does not recognize the expansion card 40 coupled to the slot 10. Therefore, the fan control unit 38 controls the rotational speed of each fan 16 by using a default control curve that does not depend on the configuration of the expansion card 40. The default control curve may be any one of the control curves held by the profile holding unit 34, or may be “MAX” illustrated in FIG. 5.

Next, in step S14, the update reception unit 31 of the BMC 30A checks whether update data of a profile (card configuration information, rotational speed information, and characteristic information) has been received from the BIOS 24A. Next, in step S16, the profile updating unit 32 of the BMC 30A executes step S18 when the update reception unit 31 has received the update data of the profile, and executes step S20 when the update reception unit 31 has not received the update data of the profile.

In step S18, the profile updating unit 32 stores the update data of the profile received from the BIOS 24A in the profile holding unit 34 to update the information held by the profile holding unit 34. By step S18, the BMC 30A may acquire the profile corresponding to the new expansion card 40 without updating the firmware. After step S18, step S20 is executed.

In step S20, the profile selection unit 36 of the BMC 30A receives, from the BIOS 24A, card information of the expansion card 40 inserted in the slot 10 and position information indicating the position of the slot 10 in which the expansion card 40 is inserted. Next, in step S22, the profile selection unit 36 selects a profile to be used for controlling the fan 16 based on the card information and position information received from the BIOS 24A.

For example, the profile selection unit 36 searches for an entry ENT corresponding to the card information and position information received from the BIOS 24A among a plurality of pieces of card configuration information held in the plurality of entries ENT of the profile holding unit 34. For example, the search for the entry ENT is executed in descending order (from top to bottom in FIG. 5), The profile selection unit 36 selects a control curve (FIG. 6) corresponding to the control curve number held in the selected entry ENT and notifies the fan control unit 38 of the selected control curve.

Next, in step S24, the fan control unit 38 continues to control the rotational speed of the fan 16 by using the control curve selected by the profile selection unit 36. The control of the fan 16 by the fan control unit 38 is continued until the CPU 20 is powered on again.

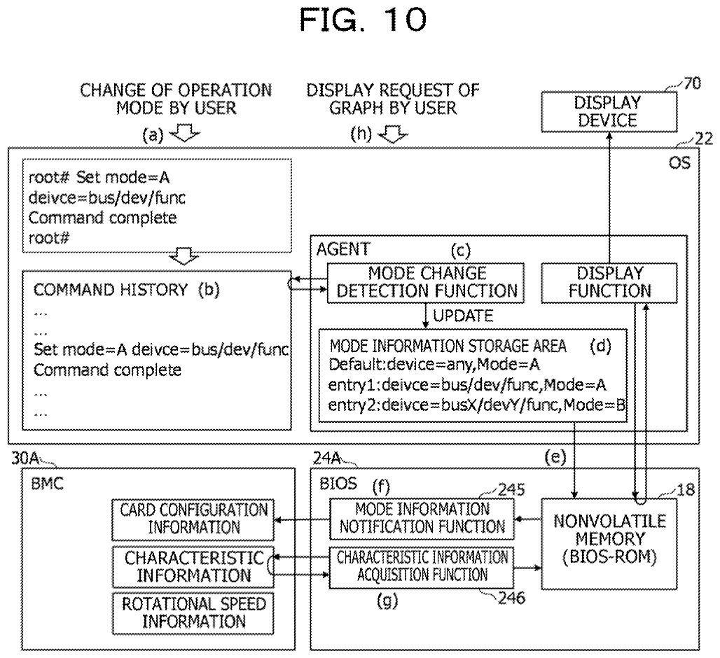

FIG. 10 illustrates an example of a display function of characteristic information in FIG. 3. For example, while the OS 22 is operating, the user of the server apparatus 100A inputs a command via the input device 60 to change the operation mode of the expansion card 40 inserted in the slot 10 ((a) in FIG. 10). The OS 22 records the command input by the user as a command history ((b) in FIG. 10).

The agent operating under the operation of the OS 22 includes a mode change detection function of detecting a change in the operation mode of the expansion card 40 based on the command history ((c) in FIG. 10). The agent that has detected a change in the operation mode stores operation mode information indicating the changed operation mode in a mode information storage area ((d) in FIG. 10). The agent stores the operation mode information in the nonvolatile memory 18 ((e) in FIG. 10).

After that, the BIOS 24A restarted by an instruction of the OS 22 uses a mode information notification function 245 to read the operation mode information (card information) from the nonvolatile memory 18. The BIOS 24A notifies the BMC 30A of the read operation mode information as card configuration information ((f) in FIG. 10). The BIOS 24A uses a characteristic information acquisition function 246 to acquire characteristic information from the BMC 30A, and stores the acquired characteristic information in the nonvolatile memory 18 ((g) in FIG. 10).

After that, the OS 22 restarted by the BIOS 24A issues, to the agent, an instruction to display the characteristic information after the change in the operation mode on the display device 70. The agent uses the display function to read, from the nonvolatile memory 18, the characteristic information after the change in the operation mode, and display a graph (FIG. 8) indicating the read characteristic information on the display device 70.

Thus, the user who has changed the operation mode of the expansion card 40 may visually check the CPU performance and power consumption after the change, and determine whether the changed operation mode is an expected one. The agent may display only the graph of the current state illustrated in FIG. 8 on the display device 70, or may display the graph of the current state and the graph before the change in the operation mode on the display device 70.

The graph may be displayed on the display device 70 in response to a display request of the graph made by the user of the server apparatus 100A ((h) in FIG. 10). In this case, the OS 22 having received the display request restarts the BIOS 24A. The restarted BIOS 24A uses the characteristic information acquisition function 246 to acquire, from the BMC 30A, characteristic information corresponding to the current operation mode of the expansion card 40 and the coupling position of the slot 10 to which the expansion card 40 is coupled, and stores the acquired characteristic information in the nonvolatile memory 18.

After that, as in the case where the operation mode is changed, the OS 22 restarted by the BIOS 24A issues, to the agent, an instruction to display the acquired characteristic information on the display device 70 based on the display request. The agent uses the display function to read the characteristic information from the nonvolatile memory 18, and display a graph indicating the read characteristic information on the display device 70.

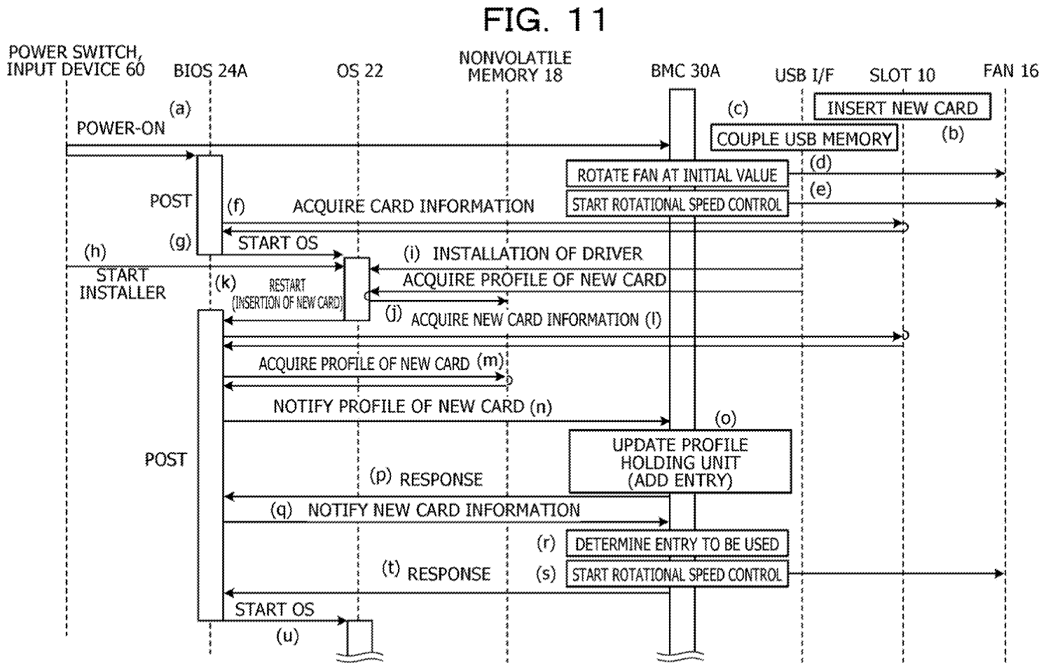

FIG. 11 illustrates an example of the operation of the server apparatus 100A in FIG. 3. Detailed description is omitted for the operation similar to that illustrated in FIG. 2. FIG. 11 illustrates an example of the temperature control method for the server apparatus 100A by the BMC 30A.

The operation illustrated in FIG. 11 is started based on power-on of the CPU 20 by operating a power switch of the server apparatus 100A ((a) in FIG. 11). Before the CPU 20 is powered on, the new expansion card 40 is inserted in the slot 10, and the USB memory 50 storing a profile corresponding to the new expansion card 40 is coupled to the server apparatus 100A ((b) and (c) in FIG. 11).

The BMC 30A rotates the fan 16 at an initial value based on power-on of the CPU 20, and then starts controlling the rotational speed of the fan 16 using a default profile based on the temperature measured by the temperature sensor 14 ((d) and (e) in FIG. 11).

The BIOS 24A is started in response to power-on of the CPU 20 and executes POST. The BIOS 24A acquires card information held in the expansion card 40 coupled to the slot 10 and position information of the slot 10 to which the expansion card 40 is coupled ((f) in FIG. 11). After that, although not illustrated, the BIOS 24A may notify the BMC 30A of the acquired card information and position information. Next, the BIOS 24A starts the OS 22, and then terminates the operation ((g) in FIG. 11).

After that, the OS 22 receives a request to start the installer from the user via the input device 60 ((h) in FIG. 11). The OS 22 uses the installer held by the USB memory 50 coupled to a USB interface (IF) to install the driver for the new expansion card 40 held by the USB memory 50 ((i) in FIG. 11).

The OS 22 acquires the profile corresponding to the new expansion card 40 from the USB memory 50 coupled to the USB interface and stores the acquired profile in the nonvolatile memory 18 ((j) in FIG. 11). After that, the OS 22 restarts the BIOS 24A with the insertion of the new expansion card 40 (acquisition of a new profile) as a starting factor ((k) in FIG. 11).

The restarted BIOS 24A executes POST, and acquires card information held in the new expansion card 40 coupled to the slot 10 and position information of the slot 10 to which the new expansion card 40 is coupled ((I) in FIG. 11). Since the starting factor is the insertion of the new expansion card 40, the BIOS 24A acquires the profile for the new expansion card 40 held in the nonvolatile memory 18 ((m) in FIG. 11).

The BIOS 24A notifies the BMC 30A of the acquired profile of the new expansion card 40 ((n) in FIG. 11). The BMC 30A updates the profile holding unit 34 by storing the received profile in an empty entry ENT of the profile holding unit 34 ((o) in FIG. 11). The BMC 30A returns, to the BIOS 24A, a response to the reception of the profile ((p) in FIG. 11).

Based on the response from the BMC 30A, the BIOS 24A notifies the BMC 30A of the card information of the new expansion card 40 (including the position information of the slot 10) ((q) in FIG. 11), The BMC 30A searches the profile holding unit 34 and determines the use of an entry ENT corresponding to the received card information ((r) in FIG. 11). The BMC 30A starts controlling the rotational speed of the fan 16 by using the information held in the determined entry ENT ((s) in FIG. 11), and returns, to the BIOS 24A, a response to the reception of the card information ((t) in FIG. 11). The BIOS 24A having received the response starts the OS 22, and then terminates the operation ((u) in FIG. 11).

In FIG. 11, as in FIG. 2, the profile corresponding to the new expansion card 40 may be transferred from the OS 22 to the BIOS 24A via the nonvolatile memory 18, and the BIOS 24A may notify the BMC 30A of the profile. Thus, the profile corresponding to the new expansion card 40 may be acquired by the BMC 30A without updating the BIOS 24A and the firmware of the BMC 30A,

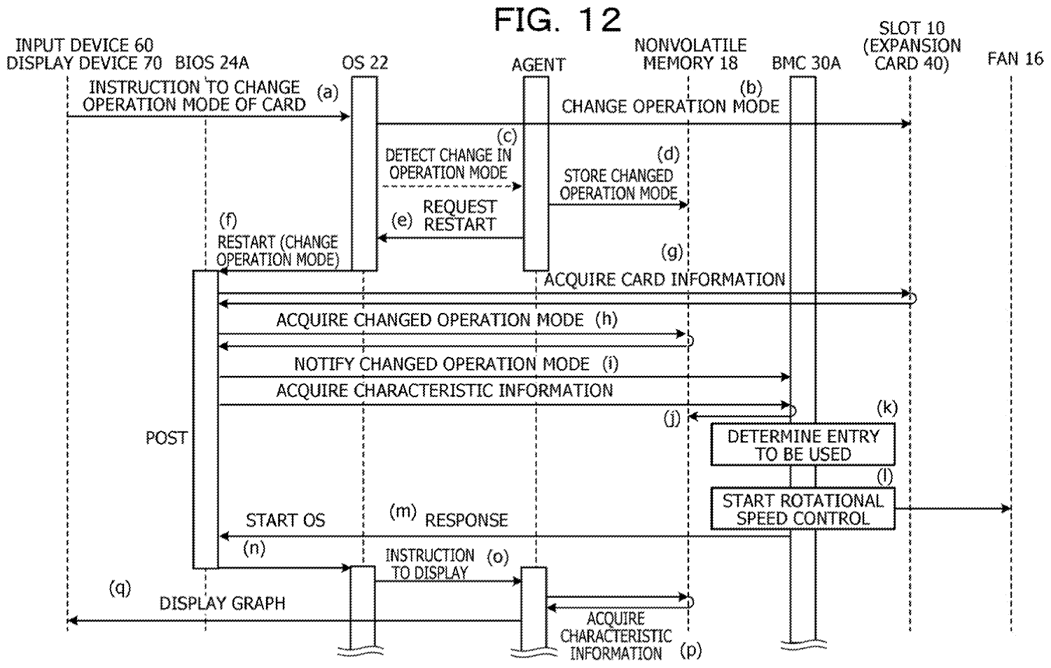

FIG. 12 illustrates another example of the operation of the server apparatus 100A in FIG. 3. Detailed description is omitted for the operation similar to those illustrated in FIG. 2 and FIG. 11. FIG. 12 illustrates another example of the temperature control method for the server apparatus 100A by the BMC 30A.

First, the OS 22 receives, from a user via the input device 60, an instruction to change the operation mode of the expansion card 40 already inserted in the slot 10 ((a) in FIG. 12). The OS 22 changes the operation mode of the expansion card 40 via the driver ((b) in FIG. 12). The agent operating together with the OS 22 detects a change in the operation mode of the expansion card 40, and stores operation mode information indicating the changed operation mode in the nonvolatile memory 18 ((c) and (d) in FIG. 12).

Next, the agent issues a request for restarting the BIOS 24A to the OS 22 ((e) in FIG. 12). Based on the restarting request from the agent, the OS 22 restarts the BIOS 24A with the change in the operation mode as a starting factor ((f) in FIG. 12).

As in FIG. 11, the restarted BIOS 24A executes POST, and acquires the position information of the slot 10 in which the expansion card 40 is inserted and the card information of the expansion card 40 ((g) in FIG. 12). Since the starting factor is the change in the operation mode, the BIOS 24A acquires, from the nonvolatile memory 18, operation mode information indicating the current operation mode (operation mode changed by the user) of the expansion card 40 inserted in the slot 10 ((h) in FIG. 12).

The BIOS 24A notifies the BMC 30A of the acquired changed operation mode of the expansion card 40 (i) in FIG. 12). The BIOS 24A acquires, from the profile holding unit 34 of the BMC 30A, a plurality of pieces of characteristic information including the characteristic information of the changed operation mode, and stores the acquired pieces of characteristic information in the nonvolatile memory 18 ((j) in FIG. 12). The acquisition of characteristic information from the BMC 30A may be done during the operation of the BIOS 24A (before the restart of the OS 22).

The BMC 30A determines the use of an entry ENT corresponding to the operation mode received from the BIOS 24A ((k) in FIG. 12). The BMC 30A starts controlling the rotational speed of the fan 16 by using the information held in the determined entry ENT ((I) in FIG. 12), and returns, to the BIOS 24A, a response to the change in the operation mode ((m) in FIG. 12).

The BIOS 24A having received the response starts the OS 22, and then terminates the operation ((n) in FIG. 12). At this time, the BIOS 24A may store, in the nonvolatile memory 18, information indicating that the starting factor of the OS 22 is a change in the operation mode of the expansion card 40.

For example, the started OS 22 refers to the nonvolatile memory 18 to detect that the starting factor is a change in the operation mode of the expansion card 40. The OS 22 issues, to the agent, an instruction to display the characteristic information after the change in the operation mode on the display device 70 ((o) in FIG. 12). The agent acquires the characteristic information after the change in the operation mode from the nonvolatile memory 18 ((p) in FIG. 12), and displays a graph indicating the acquired characteristic information on the display device 70 ((q) in FIG. 12). As illustrated in FIG. 8, the graph displayed on the display device 70 may include three performance curves respectively indicating the current state after the operation mode is changed, the case where CPU performance is improved, and the case where power consumption is reduced.

In FIG. 12, when the operation mode of the expansion card 40 is changed, the agent may acquire the characteristic information corresponding to the expansion card 40 inserted in the slot 10, the characteristic information being stored in the nonvolatile memory 18 via the BMC 30A and the BIOS 24A. For example, by using the nonvolatile memory 18, the characteristic information corresponding to the changed operation mode may be transferred from the BIOS 24A to the OS 22, the BIOS and the OS operating in a mutually exclusive manner.

The agent may display the acquired characteristic information as a graph on the display device 70. Thus, after changing the operation mode of the expansion card 40, the user may acquire a graph indicating the characteristic without actually executing jobs and evaluating CPU performance and power consumption.

As a result, it is possible to reduce the work time (for example, cost) for checking the optimum configuration of the server apparatus 100A for the change in the operation mode of the expansion card 40, compared with the case where jobs are executed to make an evaluation. For example, it is possible to reduce the time for the user to build an environment for the server apparatus 100A (time taken to consider a change in the position of the slot 10 in which the expansion card 40 is inserted and a change to various operation modes).

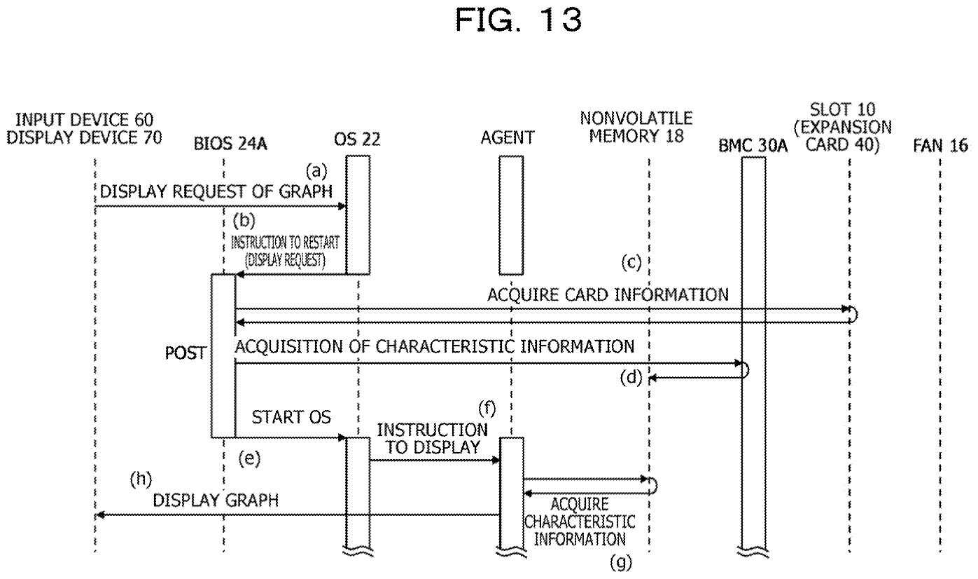

FIG. 13 illustrates still another example of the operation of the server apparatus 100A in FIG. 3. Detailed description is omitted for the operation similar to those illustrated in FIG. 2, FIG. 11, and FIG. 12. FIG. 13 illustrates still another example of the temperature control method for the server apparatus 100A by the BMC 30A.

First, the OS 22 receives, from a user via the input device 60, a display request of a graph indicating the characteristic in the current operation mode of the expansion card 40 ((a) in FIG. 13). The OS 22 restarts the BIOS 24A with the display request of the graph as a starting factor ((b) in FIG. 13).

As in FIG. 11, the restarted BIOS 24A executes POST, and acquires the position information of the slot 10 in which the expansion card 40 is inserted and the card information of the expansion card 40 ((c) in FIG. 13). The BIOS 24A acquires, from the profile holding unit 34 of the BMC 30A, the characteristic information of the expansion card 40 inserted in the slot 10, and stores the acquired characteristic information in the nonvolatile memory 18 ((d) in FIG. 13).

The BIOS 24A starts the OS 22, and then terminates the operation ((e) in FIG. 13). At this time, the BIOS 24A may store, in the nonvolatile memory 18, information indicating that the starting factor of the OS 22 is a display request of a graph. For example, the started OS 22 refers to the nonvolatile memory 18 to detect that the starting factor is a display request of a graph. The OS 22 issues, to the agent, an instruction to display the characteristic information of the expansion card 40 inserted in the slot 10 on the display device 70 ((f) in FIG. 13). As in FIG. 12, the agent acquires the characteristic information from the nonvolatile memory 18 ((g) in FIG. 13), and displays a graph (FIG. 8) indicating the acquired characteristic information on the display device 70 ((h) in FIG. 13).

In FIG. 13, when receiving a display request of a graph from the user, the agent may acquire the characteristic information corresponding to the expansion card 40 inserted in the slot 10, the characteristic information being stored in the nonvolatile memory 18 via the BMC 30A and the BIOS 24A. For example, by using the nonvolatile memory 18, the characteristic information requested to be displayed on the display device 70 may be transferred from the BIOS 24A to the OS 22, the BIOS and the OS operating in a mutually exclusive manner.

Thus, the user may acquire a graph indicating the characteristic without actually executing jobs and evaluating CPU performance and power consumption for the expansion card 40 inserted in the slot 10. As a result, it is possible to reduce the work time for checking the optimum configuration of the server apparatus 100A by considering a change in the operation mode of the expansion card 40 being inserted in the slot 10 or a change in the slot 10 to be inserted, compared with the case where jobs are executed to make an evaluation.

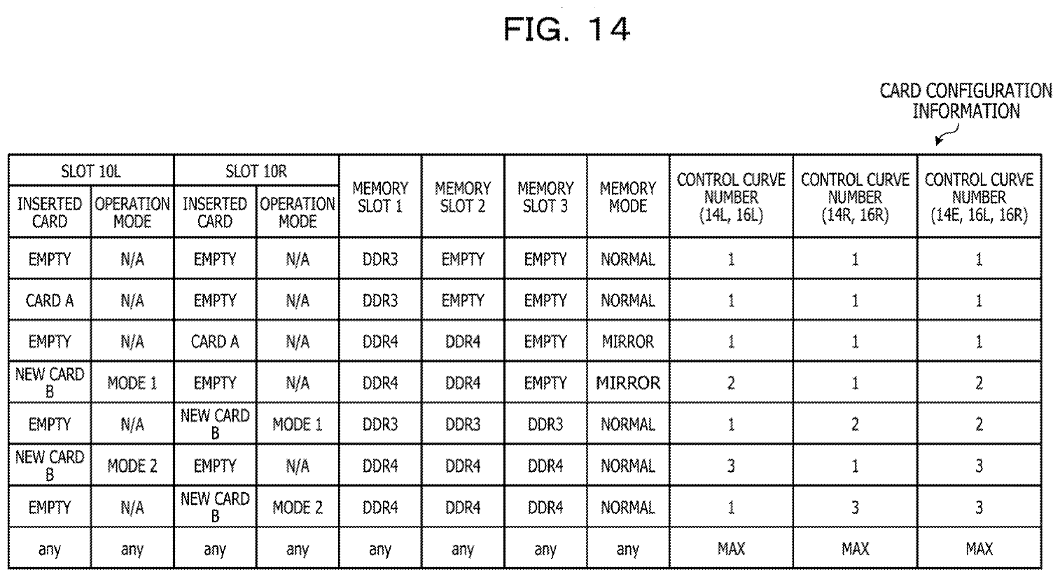

FIG. 14 illustrates another example of the card configuration information held by the profile holding unit 34 in FIG. 3. Detailed description is omitted for elements similar to those illustrated in FIG. 5.

For example, in FIG. 14, the control curve of each entry ENT of the card configuration information is determined in consideration of the specification of the memory 19 mounted in the memory slot over the motherboard of the server apparatus 100A, in addition to the information on the expansion card 40. The specification of the memory 19 includes the type of the memory 19 (for example, power consumption), the position of a memory slot in which the memory 19 is mounted, and a memory mode. The memory mode includes a normal mode and a mirror mode in which same pieces of data are redundantly stored in a plurality of memories 19.

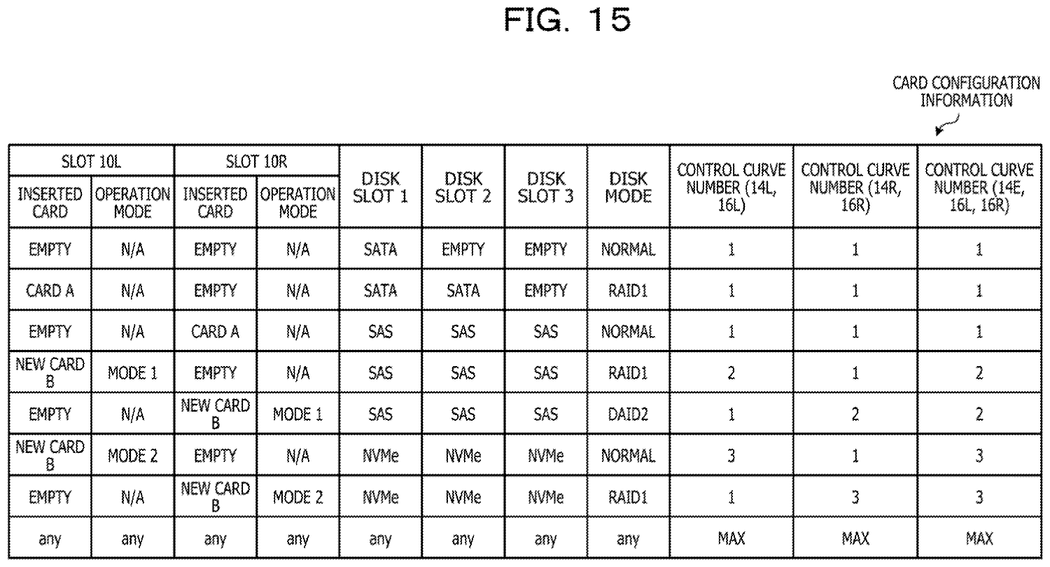

FIG. 15 illustrates still another example of the card configuration information held by the profile holding unit 34 in FIG. 3. Detailed description is omitted for elements similar to those illustrated in FIG. 5.

The control curve illustrated in FIG. 15 is determined in consideration of the specification of a disk mounted in the coupler over the motherboard of the server apparatus 100A, in addition to the information on the expansion card 40. For example, the disk includes an interface such as Serial Attached Small Computer System Interface (SCSI) (SAS), Serial Advanced Technology Attachment (SATA), or Non-Volatile Memory Express (NVMe). The disk mode of the disk includes a normal mode and various redundant arrays of inexpensive disk (RAID) modes. FIG. 15 may include the specification of the memory 19 mounted in the memory slot illustrated in FIG. 14.

As described above, even in the embodiment illustrated in FIGS. 3 to 15, the effect similar to the effect of the embodiment illustrated in FIGS. 1 and 2 may be achieved. For example, the profile corresponding to the new expansion card 40 may be acquired by the BMC 30A without updating the BIOS 24A and the firmware of the BMC 30A. As a result, control of the rotational speed of the fan 16 optimized for the new expansion card 40 may be achieved in the shipped information processing apparatus 100A without incurring development cost and work, cost for updating the firmware.

In the embodiment illustrated in FIGS. 3 to 15, when the operation mode of the expansion card 40 is changed, a graph indicating the characteristic of the changed operation mode may be displayed on the display device 70. Thus, after changing the operation mode of the expansion card 40, the user may acquire a graph indicating the characteristic without actually executing jobs and evaluating CPU performance and power consumption. As a result, it is possible to reduce the work time for checking the optimum configuration of the server apparatus 100A for the change in the operation mode of the expansion card 40, compared with the case where jobs are executed to make an evaluation.

When a display request of a graph is received from the user, a graph indicating the characteristic of the expansion card 40 inserted in the slot 10 may be displayed on the display device 70. Thus, the user may acquire a graph indicating the characteristic without actually executing jobs and evaluating CPU performance and power consumption for the expansion card 40 inserted in the slot 10. As a result, it is possible to reduce the work time for checking the optimum configuration of the server apparatus 100A by considering a change in the operation mode of the expansion card 40 being inserted in the slot 10 or a change in the slot 10 to be inserted, compared with the case where jobs are executed to make an evaluation.

The temperature in the housing of the server apparatus 100A may be appropriately controlled by setting control curves based not only on the expansion card 40 but also on a removably mounted expansion device such as the memory 19 or a disk.

Features and advantages of the embodiments will be apparent from the foregoing detailed description. The scope of claims is intended to cover the features and advantages of the embodiments as described above without departing from the spirit and scope of the claims. Any person skilled in the art may readily conceive of any improvements and changes. Accordingly, there is no intention to limit the scope of the inventive embodiments to those described above, and it is possible to rely on appropriate modifications and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A temperature control device that is mounted on an information processing apparatus together with a temperature sensor, a fan, and a plurality of coupling parts that enable coupling of an expansion device, and that controls a temperature of the information processing apparatus, the temperature control device comprising:
a memory; and
a processor coupled to the memory and configured to:
hold, in the memory, a profile that indicates a relationship between a temperature of the information processing apparatus and rotational speed of the fan for each position of the coupling part to which the expansion device is coupled;
receive, via a basic input and output program that operates exclusively with respect to an operating system, a profile for new expansion device received by the operating system when a driver for controlling a new expansion device newly mounted in the coupling part is installed in the information processing apparatus
add the profile to the memory;
select one of a plurality of profiles held in the memory in accordance with an expansion device coupled to the coupling part detected by the basic input and output program; and
control rotational speed of a fan based on a temperature detected by the temperature sensor by using a selected profile.

2. The temperature control device according to claim 1,
wherein the processor holds a profile for each operation mode of the expansion device in the memory, and
wherein when an operation mode of the expansion device coupled to the coupling part is changed during operation of the operating system, the processor selects a profile corresponding to a changed operation mode notified via the basic input and output program.

3. The temperature control device according to claim 1,
wherein the processor further holds a default profile that does not depend on the expansion device coupled to the coupling part in the memory, and
wherein the processor selects the default profile when the processor does not hold a profile corresponding to an expansion device coupled to the coupling part.

4. An information processing apparatus comprising a first processor, a temperature sensor, a fan, a plurality of coupling parts that enable coupling of an expansion device, and a temperature control device that controls operation of the fan based on a temperature detected by the temperature sensor,
wherein the temperature control device includes:
a memory; and
a second processor coupled to the memory and configured to:
hold, in the memory, a profile that indicates a relationship between a temperature of the information processing apparatus and rotational speed of the fan for each position of the coupling part to which the expansion device is coupled;
receive, via a basic input and output program that operates exclusively with respect to an operating system, a profile for new expansion device received by the operating system when a driver for controlling a new expansion device newly mounted in the coupling part is installed;
add the profile to the memory;
select one of a plurality of profiles held in the memory in accordance with an expansion device coupled to the coupling part detected by the basic input and output program; and
control rotational speed of a fan based on a temperature detected by the temperature sensor by using a selected profile.

5. The information processing apparatus according to claim 4,
wherein the apparatus includes a nonvolatile memory allocated to a memory space accessible from the operating system and the basic input and output program,
wherein the operating system stores a received profile for new expansion device in the nonvolatile memory and then restarts the basic input and output program,
wherein the restarted basic input and output program acquires a profile for new expansion device from the nonvolatile memory and notifies the temperature control device of the profile, and
wherein the second processor adds, to the memory, a profile for new expansion device notified from the basic input and output program.

6. The information processing apparatus according to claim 5,
wherein the processor further holds, in the memory, a profile for each operation mode of the expansion device, and
wherein when an operation mode of the expansion device coupled to the coupling part is changed during operation of the operating system, the second processor selects a profile corresponding to a changed operation mode notified via the basic input and output program.

7. The information processing apparatus according to claim 6,
wherein when the operating system changes an operation mode of the expansion device coupled to the coupling part, the operating system stores operation mode information indicating a changed operation mode in the nonvolatile memory and restarts the basic input and output program, and
wherein the basic input and output program restarted based on a change in an operation mode acquires the operation mode information from the nonvolatile memory and notifies the temperature control device of the operation mode information.

8. The information processing apparatus according to claim 7,
wherein the profile for new expansion device received by the operating system includes characteristic information in each operation mode for each position of the coupling part to which the new expansion device is coupled,
wherein the basic input and output program restarted based on a change in an operation mode further acquires, from the temperature control device, characteristic information of the expansion device of which an operation mode is changed, stores acquired characteristic information in the nonvolatile memory, and restarts the operating system, and
wherein the restarted operating system acquires characteristic information from the nonvolatile memory and displays acquired characteristic information on a display device.

9. The information processing apparatus according to claim 4,
wherein the apparatus includes a nonvolatile memory allocated to a memory space accessible from the operating system and the basic input and output program
wherein the profile for new expansion device received by the operating system includes characteristic information in each operation mode for each position of the coupling part to which the new expansion device is coupled,
wherein when the operating system receives a display request of characteristic information of the expansion device coupled to the coupling part, the operating system restarts the basic input and output program,
wherein the basic input and output program restarted based on reception of the display request acquires, from the temperature control device, characteristic information of the expansion device coupled to the coupling part, stores acquired characteristic information in the nonvolatile memory, and restarts the operating system, and
wherein the restarted operating system acquires characteristic information from the nonvolatile memory and displays acquired characteristic information on a display device.

10. The information processing apparatus according to claim 4,
wherein the apparatus includes an input and output interface to which a recording medium is removably coupled, and
wherein the operating system receives the driver and the profile for new expansion device via a recording medium coupled to the input and output interface.

11. The information processing apparatus according to claim 4,
wherein the temperature control device is included in a management device that manages the processor.

12. A temperature control method for an information processing apparatus by a temperature control device mounted on the information processing apparatus together with a temperature sensor, a fan, and a plurality of coupling parts that enable coupling of an expansion device, the temperature control method comprising:
the temperature control device
receiving, via a basic input and output program that operates exclusively with respect to an operating system, a profile that indicates, for each position of the coupling part to which a new expansion device is coupled, a relationship between a temperature of the information processing apparatus and rotational speed of the fan, the profile being received by the operating system when a driver for controlling the new expansion device newly mounted in the coupling part is in the information processing apparatus, and adding the profile to the memory;
selecting one of a plurality of profiles held in the memory in accordance with an expansion device coupled to the coupling part detected by the basic input and output program; and
controlling rotational speed of a fan based on a temperature detected by the temperature sensor by using a selected profile.
